(19) United States
(12) Patent Application Publication
(10) Pub. No.: US 2013/0301806 A1
(43) Pub. Date: Nov. 14, 2013

(54) COMPOSITE CRYSTAL ARRAY FOR PIXELATED GAMMA CAMERA AND METHOD OF MAKING THEREOF

(71) Applicants: Hsin-Chin Liang, Taoyuan County (TW); Ching-Wei Kuo, Taoyuan County (TW); Meei-Ling Jan, Taoyuan County (TW)

(72) Inventors: Hsin-Chin Liang, Taoyuan County (TW); Ching-Wei Kuo, Taoyuan County (TW); Meei-Ling Jan, Taoyuan County (TW)

(73) Assignee: Institute of Nuclear Energy Research Atomic Energy Council, Executive Yuan, Taoyuan County (TW)

(21) Appl. No.: 13/633,246

(22) Filed: Oct. 2, 2012

(30) Foreign Application Priority Data
May 8, 2012 (TW) 101116340

(51) Int. Cl. G21K 1/06; B23P 11/00; B32B 37/12

(52) U.S. Cl. 378/145; 156/60; 29/428

(57) ABSTRACT

A composite crystal array for a pixelated gamma camera and a method of making thereof, which are adapted to a photoelectric matrix that consists of position sensitive photomultiplier elements, in which the photoelectric matrix is divided into sensible and non-sensible areas with a geometric distribution, so as to set a ratio of a segmented region; a configuration detail of a partial optical splitting crystal array and a configuration detail of a whole optical splitting crystal array are set according to the ratio of the segmented region; and the partial optical splitting crystal array and the whole optical splitting crystal array are made according to the two configuration details, and two kinds of crystal arrays are combined to form a whole crystal array for the pixelated cameras according to the segmented region, so that the effective area of the pixelated camera is kept continuous and the resolution thereof is kept uniform.

### BACKGROUND OF THE INVENTION

1. Field of Invention

The present invention relates to a composite crystal array for a pixelated gamma camera and a method of making thereof, which are adapted to a photoelectric matrix that consists of a plurality of position sensitive photomultiplier elements; and provide the composite crystal array that is combined from a whole optical splitting configuration and a partial optical splitting configuration according to a certain ratio, in which the certain ratio is set according to sensible and non-sensible areas with a geometric distribution in the photoelectric matrix, and is obtained according to the method in the present invention. In the composite crystal array, the whole optical splitting configuration is able to correspond to a photoelectrical area of the photoelectric matrix, and the partial optical splitting configuration is able to correspond to the non-sensible area, so that the out-going lights from the crystals over the non-sensible, discontinuous area is able to enter the photoelectrical area of two adjacent position sensitive photomultiplier elements, so as to solve a problem of a discontinuous crystal position response and at the same time keep a desirable resolution that is uniform in a whole imaging area.

2. Related Art

A nuclear medicine imaging technology, such as positron emission tomography (PET) and single-photon emission computed tomography (SPECT), provides vivo functional information to compensate for the deficiencies in anatomical images, such as ultrasound, computerized tomography (CT) and magnetic resonance imaging (MRI), so that a nuclear medicine imaging technology has the advantages such as high sensitivity, non-invasiveness and high reproducibility and is widely applied for diagnosing some diseases. In a nuclear medicine imaging machine, a gamma camera is the core component of the whole machine.

To improve the resolution performance of a camera, the use of a position sensitive photomultiplier element, for example, a position sensitive photomultiplier tube (PSPMT), is an effective solution. The size of an effective area of the camera depends on a combination of multiple position sensitive photomultiplier elements (a photoelectric matrix thereinafter), but a non-sensible, discontinuous area might occur between two adjacent photomultiplier elements due to the combination thereof, leading to the phenomenon of an discontinuous crystal position response, which may become more serious as the area of the camera grows larger (more position sensitive photomultiplier elements are combined).

To solve the above problem, at least two modes exist. In one mode, a light transmission medium with a thickness (about more than 2 mm) of a coverage area and a refractive index of about 1.5, for example, an optical glass is coupled between the illuminated surfaces of a whole optical splitting crystal array and a photoelectric matrix, so as to enlarge a light cone of a transmitted light from each crystal unit in the crystal array, so that the incident lights from the crystals over the non-sensible, discontinuous area are able to enter the photoelectrical area of two adjacent position sensitive photomultiplier elements, accordingly, the event flashes sent by those crystals may be measured and located to achieve the purpose of imaging. Although the problem of a discontinuous crystal position response can be solved, the mode may deteriorate the resolution of a whole imaging area by at least 25% and a crystal position response pattern becomes fuzzy, leading to the failure in well-separating events of each crystal and correctly determining the crystal where the event occurs, which, as an evidence for event accumulation, results in a fuzzy image reconstructed subsequently, so that the overall image quality is affected and the diagnostic difficulty is increased.

In the other mode, a tapered fiber bundle with a scaling ratio is coupled between a bottom side of the crystal array as an illuminated surface and the incoming window of the photoelectric matrix; a matrix is formed of a plurality of tapered fiber bundles and the connection end of the crystal arrays has a continuous surface, and the connection end of the photoelectric matrixes is discontinuous and only corresponds to the effective photoelectrical area of each position sensitive photomultiplier element. Although the problem of the discontinuous position response can be solved, the mode may reduce the coverage area of the light cone causing that a crystal of a smaller size cannot be used, and also has the similar defect of deteriorating all the resolutions as in the aforementioned mode. Moreover, the unit price of the tapered fiber bundle is high and thus a single camera requires a considerable amount of tapered fiber bundles, which is not cost effective.

Therefore, both the modes have defects of resolution deterioration and low cost effectiveness, so that both the modes can be further optimized.

### SUMMARY OF THE INVENTION

In view of the defects described above, an objective of the present invention is to provide a composite crystal array for a pixelated gamma camera and a method of making thereof, which are adapted to a photoelectric matrix that consists of position sensitive photomultiplier elements, in which the photoelectric matrix is divided into sensible and non-sensible areas with a geometric distribution, so as to set a ratio of a segmented region; a configuration detail of a partial optical splitting crystal array and a configuration detail of a whole optical splitting crystal array are set according to the ratio of the segmented region. The partial optical splitting crystal array and the whole optical splitting crystal array are made according to the two configuration details, and two kinds of crystal arrays are combined according to the segmented region to from the whole crystal array of the camera, in which, by modifying the height of the retroreflective material between the crystal sidewalls of the partial optical splitting crystal array, the partial optical splitting crystal array makes the height of the retroreflective material to decrement from its two ends towards its center, and show expected modifications with the position changes with expectably changing the coverage areas of the outgoing light cone of each crystal in a region having a light transmission gap material instead of the retroreflective material on the sidewells, so that flickering lights of crystals across or near the non-sensible area may be detected and the position thereof may be determined. Therefore, the configuration of the composite crystal array made according to the geometric distribution of the target photoelectric matrix is not only able to solve the problem of discontinuous crystal position response in the non-sensible areas of the camera but also able to keep the resolution in the whole area uniform. Moreover, the present invention does not have the defects such as resolution deterioration or low cost effectiveness.

To achieve the objective, a technical solution of the present invention provide a method of making a composite crystal array for a pixelated gamma camera, and the method comprises the following steps:

providing sensible dimensional sizes of a first dimension and a second dimension of two adjacent position sensitive photomultiplier elements of a photoelectric matrix, where the two adjacent position sensitive photomultiplier elements have a dimensional size Y1 on the first dimension and a dimensional size W2 on the second dimension, a non-sensible, discontinuous area exists between the two position sensitive photomultiplier elements, and the non-sensible, discontinuous area has a dimensional size Y2 on the first dimension;

providing a specification for a partial optical splitting crystal array, where the partial optical splitting crystal array has a dimensional size W1 on the first dimension, W1 is Y2+(Y1×a ratio)×2, W1 has N1 crystals, and the partial optical splitting crystal array has N2 crystals in another dimension size, so that the total number of the crystals of the partial optical splitting crystal array is N1×N2 and the height of the crystal is L;

providing a retroreflective material of the partial optical splitting crystal array, where the height (H) of the retroreflective material is smaller than the height L of the crystal and decrements from two sides (H=L) of the partial optical splitting crystal array towards the center thereof;

providing N1×N2 crystals for the retroreflective material of the partial optical splitting crystal array, where the N1×N2 crystals are set in the retroreflective material to form a partial optical splitting crystal array, and a light transmission gap material is set in each gap, and the height of the light transmission gap material is L−H; and

combining the partial optical splitting crystal array with the whole optical splitting crystal array, where the partial optical splitting crystal array is combined with at least one whole optical splitting crystal array to form a whole crystal array.

The present invention further provides a composite crystal array for a pixelated gamma camera, which comprises:

a partial optical splitting crystal array, having a retroreflective material, where the retroreflective material forms a grid, the retroreflective material has a height H, and the height H decrements from the two sides of the partial optical splitting crystal array towards the center thereof; a plurality of crystals, each having a height L, where L is larger than H, the crystals are set in the grid and a gap is formed between the crystal sidewall and its neighbor crystal sidewall, the height of the gap is L−H; and a light transmission gap material set in the gap; and

at least one whole optical splitting crystal array set on at least one side of the partial optical splitting crystal array.

In the partial optical splitting crystal array and the method of making thereof of the present invention, the height of the retroreflective material of the partial optical splitting crystal array is changed, that is, the height decrements form the two sides of the partial optical splitting crystal array towards the center thereof, and the light transmission gap material is set in each gap of the partial optical splitting crystal array, so that the change of the height and the light transmission gap material enable incident lights of the crystal over the non-sensible, discontinuous area to enter sensible areas of the two adjacent position sensitive photomultiplier elements, so as to accomplish the determination of an event position. The whole optical splitting crystal array provides an imaging signal source in an original sensible area of each element in the photoelectric matrix, the gap between the side surface of each crystal and the retroreflective material (mask) is filled with a material with a low refractive index, and the height of the retroreflective material is the same with the height of the crystal. The crystal arrays with the two configuration are combined in a certain ratio according to the geometric distribution of the sensible and non-sensible areas in the position sensitive photoelectric matrix, so that the problem that the non-sensible area of the photoelectric matrix causes the discontinuous crystal position response may be solved, the effective imaging area of an image camera is complete and continuously cover at least more than 85% of the area of the photoelectric matrix, and the resolutions in the whole effective area are kept uniform. Moreover, the present invention also provides a method to achieve the making of the crystal array in a cost effective fashion, and can solve the problem of discontinuous crystal position response without affecting the resolution and in a cost effective fashion.

### BRIEF DESCRIPTION OF THE DRAWINGS

FIG. 1 is a schematic flow chart of a method of making a composite crystal array for a pixelated gamma camera of the present invention;

FIG. 2 is a schematic diagram of two adjacent position sensitive photomultiplier elements;

FIG. 3 is a schematic diagram of a partial optical splitting crystal array of the present invention;

FIG. 4 is a schematic diagram of a whole optical splitting crystal array of the present invention;

FIG. 5 is a partial exploded schematic diagram of a whole optical splitting crystal array;

FIG. 6 is a schematic diagram of setting a whole crystal array in two adjacent position sensitive photomultiplier elements of the present invention;

FIG. 7 is a schematic diagram of a grid formed by a retroreflective material of a partial optical splitting crystal array;

FIG. 8 is a schematic action diagram of setting a crystal in a grid for a partial splitting crystal array;

FIG. 9 is a schematic diagram of setting a crystal in a grid for a partial splitting crystal array; and

FIG. 10 is a schematic diagram of a composite crystal array for a plurality of adjacent position sensitive photomultiplier elements.

### DETAILED DESCRIPTION OF THE INVENTION

The implementations of the present invention are described below with reference to special and detailed embodiments, and it is easy for persons of ordinary skill in the art to understand other advantages and efficacies of the present invention based on the disclosed contents of the specification.

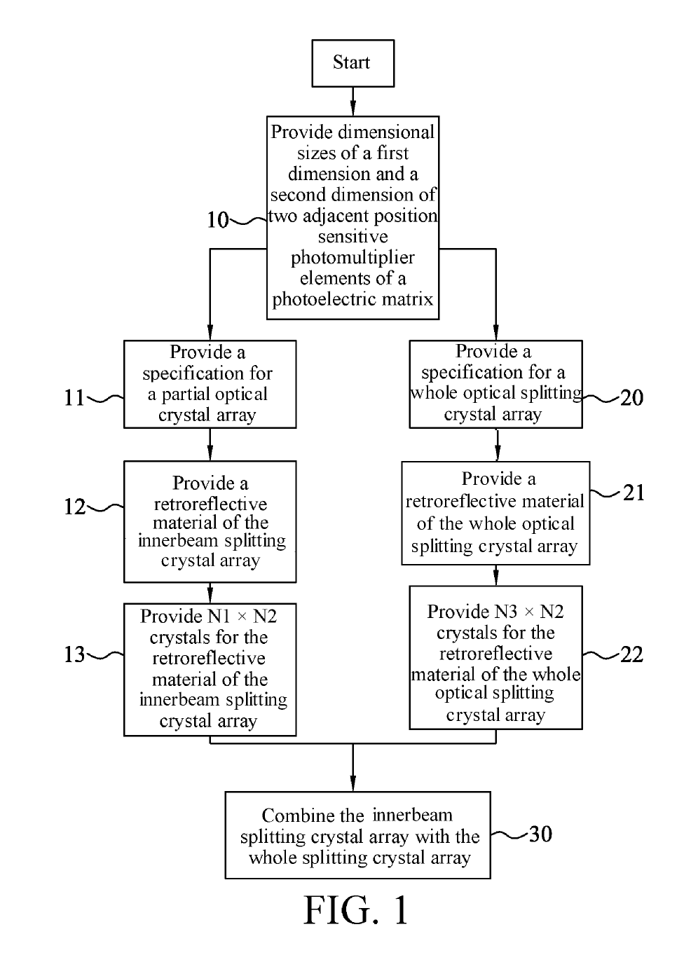

Referring to FIG. 1, the present invention is a method of making a composite crystal array for a pixelated gamma camera, which includes the following steps.

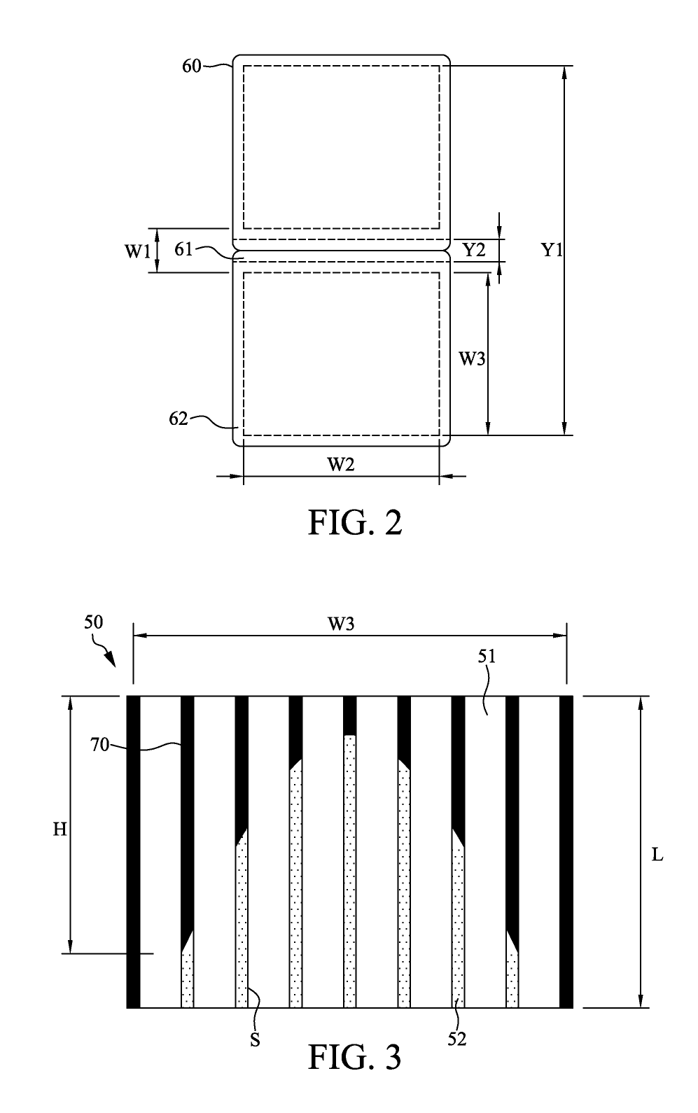

Provide sensible dimensional sizes 10 of a first dimension and a second dimension of any two adjacent position sensitive photomultiplier elements of a photoelectric matrix. Referring to FIG. 2 and FIG. 3, any two adjacent position sensitive photomultiplier elements (for example, position sensitive photomultiplier tubes, PSPMT hereinafter) 62 in a photoelectric matrix 60 have a dimensional size Y1 on the first dimension and a dimensional size W2 on the second dimension, a non-sensible, discontinuous area 61 exists between the two PSPMTs 62 in a photoelectric matrix 60, the non-sensible, discontinuous area 61 has a dimensional size Y2 on the first dimension, the size of Y2 is 2% to 10% of Y1, and the photoelectric matrix is formed of the multiple position sensitive photomultiplier elements.

A specification 11 for a partial optical splitting crystal array is provided, where the partial optical splitting crystal array 50 has a dimensional size W1 on the first dimension, W1 is Y2+(Y1×a ratio)×2, the ratio is 3% to 8%; the partial optical splitting crystal array 50 has N1 crystals on the first dimension, the number is an integer and is smaller than 100, for example, preferably, the number is an even number, such as the number of 2-16 and the objective of N1 being an even number is to avoid that the center of a crystal pixel 51 is aligned with the center of a non-sensible, discontinuous area 61, the unilateral size of the crystal pixel 51 on the first dimension is the same as the unilateral size of the crystal pixel thereof on the second dimension, and the unilateral size of the crystal pixel is P, P=W1/N1−S, S is a gap of the crystal 51, S is 0.05 mm-0.2 mm, the gap S is to be set with a light transmission gap material 52, a retroreflective material 70, the light transmission gap material 52 is a material transmittable to an incident light with a wavelength between 300 nm and 700 nm and has a transparency >95%, and a refractive index larger than 1.45, the thickness of the material of the retroreflective material 70 should be smaller than 100 μm and the surface is able to reflect or absorb the incident light with the wavelength between 300 nm and 700 nm.

Referring to FIG. 2, the crystal 51 of the partial optical splitting crystal array 50 has N2 crystals 51 in the direction of the second dimension, so N2′=W2/(P+S), the N2′ may be rounded to the number of the crystals on the second dimension N2, so that the total number of the crystals 51 of the partial optical splitting crystal array 50 is N1×N2; if the crystal array size on the second dimension is WA2=N2 (P+S), only WA2≦W2 is checked, and if WA2>W2, only one row needs to be reduced, that is, N2′=N2−1.

N1 depends on the resolution specification of a camera, P depends on W1 and N1, and N2 is calculated through P and W2 in combination.

A retroreflective material 12 of a partial optical splitting crystal array is provided, as shown in FIG. 3, the crystal 51 has a height L, the height H (H hereinafter, and the unit is mm) of the retroreflective material 70 is smaller than L, the retroreflective materials 70 are cut flush with the upper edge of crystal 51, H decrements from the two sides of the partial optical splitting crystal array 50 towards the center thereof, for example, H can be obtained from one of a linear-curve equation, a quadratic curve equation, a logarithmic curve equation, and an exponential equation.

In the case of a linear-curve equation, H is H(X)=aX+b; X is the number of the crystal gap, by taking the central gap of the partial optical splitting crystal array 50 as 0,X increments by an integer towards the two sides till X=N1/2; a and b are constants, the range of a is 0.1˜5, and the range of b is 5˜25.

In the case of a quadratic curve equation, H is H(X)=a×X²+b×X+c; a, b and c are constants, the range of a is 0.2˜1.8, the range of b is −2.8˜5.3 and the range of c is −2˜6.3.

In the case of a exponential curve equation, H is H(X)=a×exp(b×X), a and b are constants, the range of a is 0.1˜3.1 and the range of b is 0.19˜1.2.

In the case of an exponential equation, H is H(X)=a×2^{(b×X)}, a and b are constants, the range of a is 0.21˜3.3, and the range of b is 0.1˜2.3.

In the case of an exponential equation, H is H(X)=a×10^{(b×X)}, a and b are constants, the range of a is 0.13˜3.1, and the range of b is 0.1˜0.9.

Provide N1×N2 crystals for the retroreflective material 13 of the partial optical splitting crystal array. As shown in FIG. 3, the N1×N2 crystals 51 obtained in the above step are set in the retroreflective material 70 to form a partial optical splitting crystal array 50, and each gap S is set with the light transmission gap material 52, that is, the light transmission gap material 52 is located between the crystal 51 and the retroreflective material 70. To put it another way, the light transmission gap material 52 is located in the gap S generated between two crystal sidewall and by the retroreflective material 70 whose height decrements from the two sides towards the center and the crystal array 50. As shown in FIG. 3, if the height of the retroreflective material 70 is H, the height of the light transmission gap material 52 is L−H, the light transmission gap material 52 should be a transparent material with the refractive index larger than 1.45, for example, a light transmission curable adhesive and a light transmission UV adhesive.

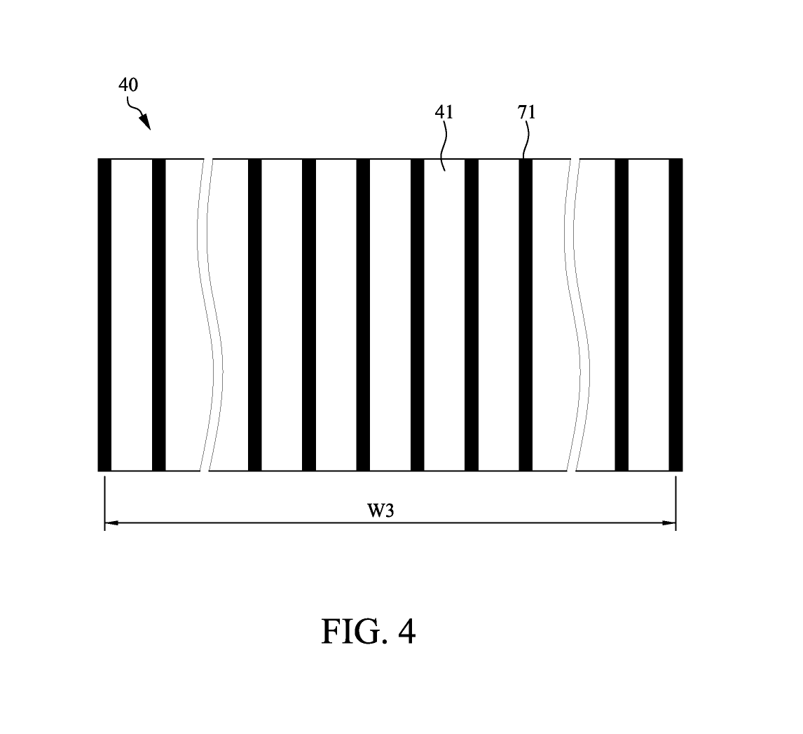

Provide a specification 20 for the whole optical splitting crystal array. As shown in FIG. 2 and FIG. 4, the size (P) of the crystal 41 and the gap (S) of the crystal 41 of the whole optical splitting crystal array 40 all follow the above partial optical splitting crystal array 50, but a single whole optical splitting crystal array 40 is the same as the partial optical splitting crystal array 50 on the first dimension. If the dimensional size of the whole optical splitting crystal array 40 on the first dimension is not equal to W3, a row of the particles of the crystal 41 is reduced or the size of the crystal 41 is changed accordingly, W3=(Y1−W1)/2 and the whole optical splitting crystal array 40 has N3 crystals 41 on the first dimension, N3′=W3/(P+S) and then N3′ is rounded to obtain N3, so that the total size of the whole optical splitting crystal array 40 on the first dimension is WA3, WA3=N3 (P+S), WA3/W3=r and r is a ratio; if r=1 or is a number within 97.5%˜102.5%, P does not need to change and only S needs to be adjusted; if r is larger than 102.5%, a row of the crystals is reduced, that is, N3″=N3−1, and the size of the crystal 41 is recalculated to be P′=W3/N3″−S, the value of P′ is rounded to two digits after the decimal point and the unit is mm; if r is smaller than 97.5%, a row is added and the size of the crystal 41 is recalculated, that is, N3″=N3+1, the size of the crystal 41 is P′=W3/N3″−S and is rounded to two digits after the decimal point, and the unit is mm, reassign N3″ as N3, so that the number of the crystals 41 of the whole optical splitting crystal array is N2×N3.

Provide a retroreflective material 21 of the whole optical splitting crystal array. As shown in FIG. 4, the height of the retroreflective material 71 is cut flush with an upper edge and the lower edge of the crystal 41, respectively, the retroreflective material 71 also forms a grid, and as described above, the height of the retroreflective material 71 is equal to L.

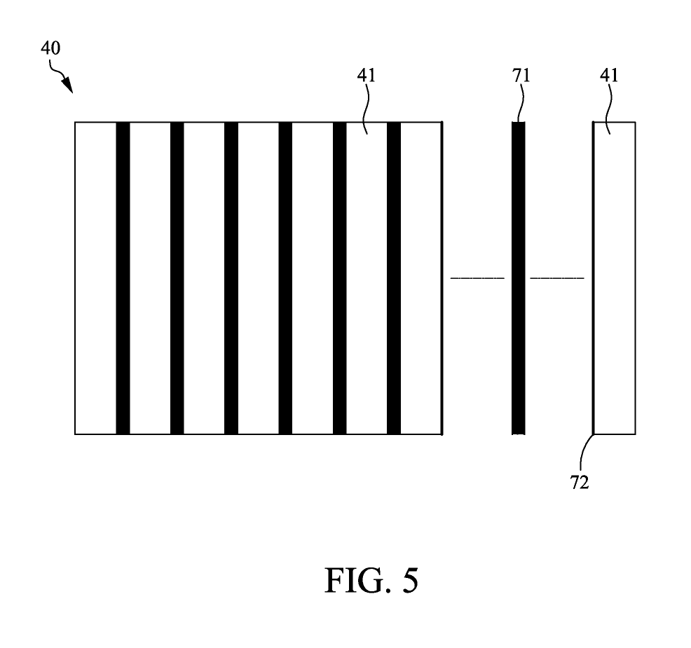

Provide N2×N3 crystals for a retroreflective material 22 of the whole optical splitting crystal array. The N2×N3 crystals 41 obtained in the above step are set in the retroreflective material 71 to form a whole optical splitting crystal array 40. As shown in FIG. 5, the sidewall surface of the crystal 41 is able to be selectively set with the light transmission material (not shown), for example, the light transmission curable adhesive 72 or air. The making mode and structure of the whole optical splitting crystal array 40 belong to the prior art, and is described in detail in Robert S. Miyaoka, Steve G. Kohlmyer, and Tom K. Lewellen, “Performance Characteristics of Micro Crystal Element (MiCE) Detectors”, IEEE TRANSACTIONS ON NUCLEAR SCIENCE, VOL. 48, NO. 4, AUGUST 2001, and it should be noted that, the steps described above are merely brief descriptions.

Alternatively, a residual area which is divided into at least two equal parts by the partial optical splitting crystal array area should be filled with at least two same whole optical splitting crystal arrays. Every whole optical splitting crystal array has a first dimensional size W3 and a second dimensional size W2, where W3 is (Y1−W1)/2; after the calculation of the crystal unilateral size P and W3 in combination, the number N3 of the crystals of the whole optical splitting crystal array on the first dimension may be obtained, so that the number of the whole optical splitting crystal array should be N3×N2, and the residual area is the area having no corresponding partial optical splitting crystal array 50 of a position sensitive photomultiplier element 60.

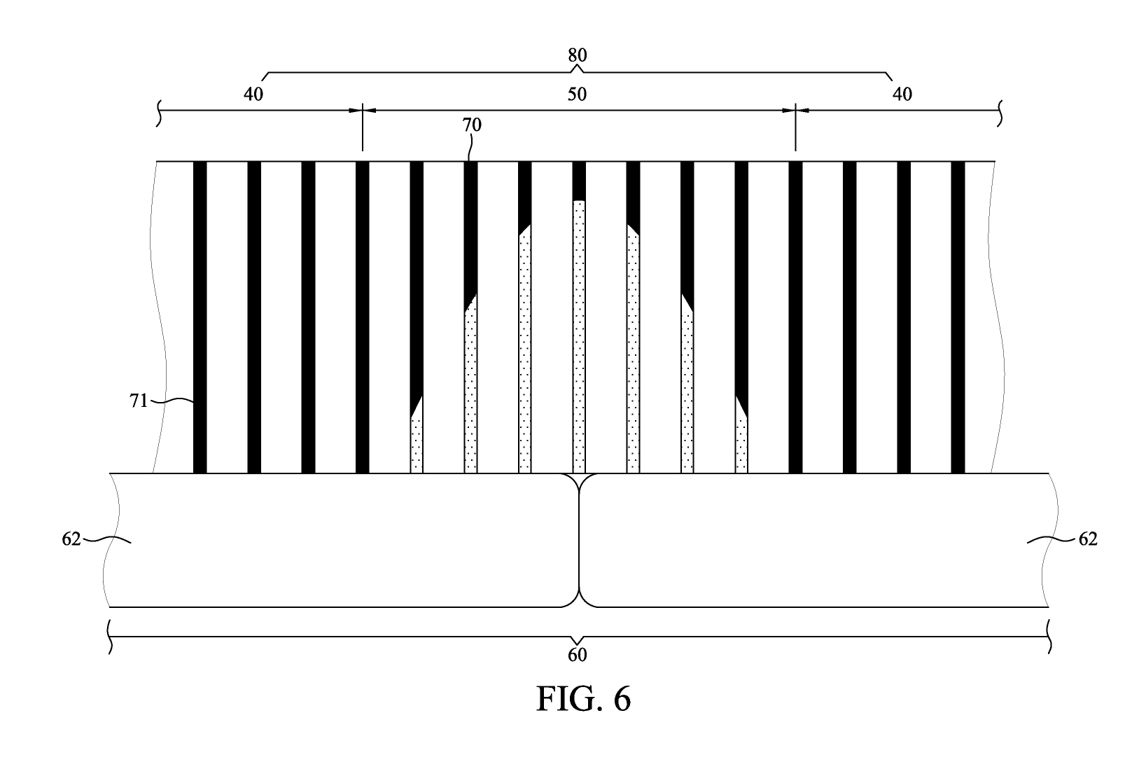

In combination of the partial optical splitting crystal array and the whole optical splitting crystal array 30, as shown in FIG. 6, the partial optical splitting crystal array 50 obtained by the above step is combined with at least one whole optical splitting crystal array 40 to form a whole crystal array 80, the whole crystal array 80 is set in the above photoelectric matrix 60, and any two position sensitive photomultiplier elements 62 in the photoelectric matrix 60 are close to each other.

With reference to the following diagrams and descriptions, the steps of making of the above partial optical splitting crystal array 50 is further described.

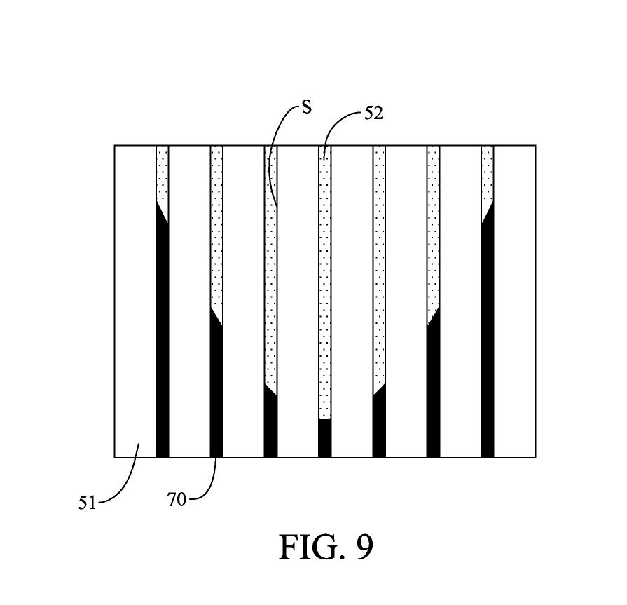

Referring to FIG. 7 to FIG. 9 and FIG. 3, as discussed in the step of providing the retroreflective material of the partial optical splitting crystal array, the retroreflective material 70 forms a grid 53. As described above, the height of the retroreflective material 70 decrements from the two sides towards the center; the top of the grid 80 is adhered flush to a plane; and the surface of the crystal 51 is able to be set with the light transmission gap material 52, for example, the light transmission curable adhesive, which is inserted inside the grid 53 from the bottom of the grid 53 until the grid 53 is filled with the crystal 51. Here, because of the liquidity, the wet adhesive mixes with the adhesives in other gaps pushed by the retroreflective material 70, and fills the crystal gap S. When cured, the adhesive becomes a continuous light transmission gap material, so that a partial optical splitting crystal array 50 is formed, and here, the partial optical splitting crystal array 50 is turned over to make the top upward and the bottom facing the plane, as shown in FIG. 3.

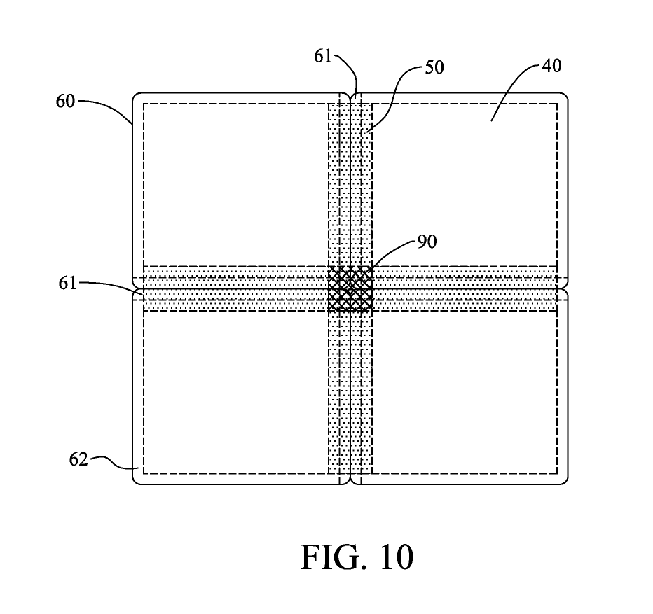

Referring to FIG. 10, as described above in the step of providing the dimensional sizes of a first dimension and a second dimension, the two position sensitive photomultiplier elements (PSPMTs) 60 may also be a combination of multiple position sensitive photomultiplier elements 60. As shown in FIG. 10, in the case of a combination of multiple position sensitive photomultiplier elements 62, the method of making a composite crystal array for a pixelated gamma camera is the same as the description above.

Further referring to FIG. 6, the present invention is a composite crystal array for a pixelated gamma camera, which has a partial optical splitting crystal array 50 and at least one whole optical splitting crystal array 40.

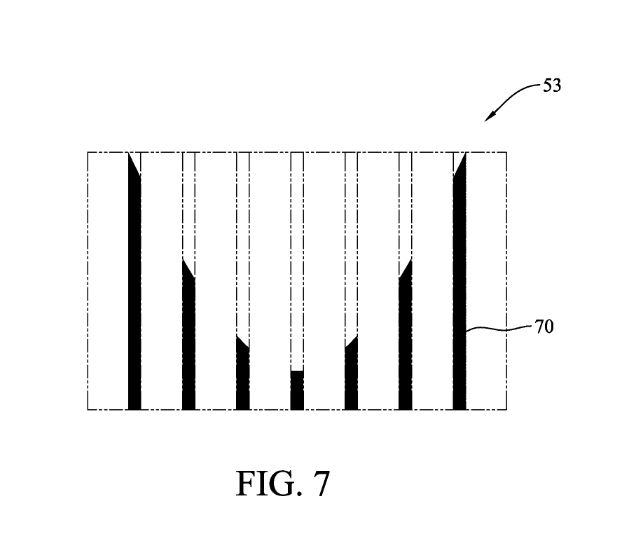

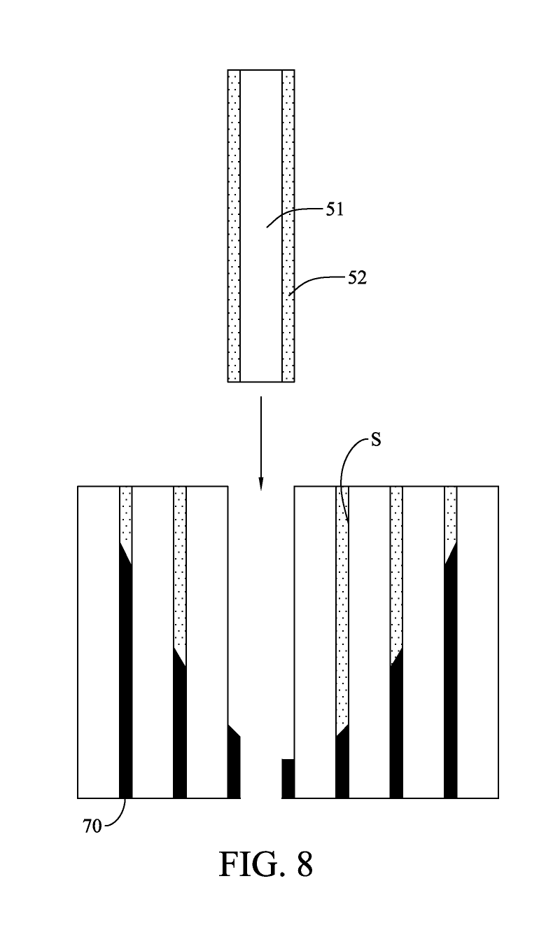

As shown in FIG. 3, the partial optical splitting crystal array 50 has a plurality of crystals 51, a retroreflective material 70 and a light transmission gap material 52, where the retroreflective material 70 forms a grid 53, the height of the retroreflective material 70 is smaller than that of the crystal 51 and decrements from the two sides of the partial optical splitting crystal array 50 towards the center thereof. As shown in FIG. 7, the number of the plurality of crystals 51 is N1×N2, the crystal 51 is set in the retroreflective material 70 and the top of the crystal 51 is cut flush with the top of the grid, and the light transmission gap material 52 is set in the gap S between two sidewalls of each crystal 51 and its neighbor one. Same as the above, the height of the gap S is L−H, so that the height of the light transmission gap material 52 is L−H.

When the position sensitive photomultiplier element 62 are combined in two dimensions to expand the photoelectric matrix 60, a corresponding smaller special partial optical splitting crystal array 90 is required on a junction of four elements, and the number of the used crystals is N1×N1. The changes of the height of the retroreflective material 70 among the crystal arrays of the partial optical splitting crystal array 50 are merely implemented in one dimension crossing the non-sensible, discontinuous area 61, and for the special partial optical splitting crystal array 90, the changes of the height of the retroreflective material 70 requires to be implemented in both dimensions; except that, other crystal array parameters, such as the height of the crystal, the size of the crystal and the height of the retroreflective material 70 are the same for the both.

As is shown in FIG. 5, the whole optical splitting crystal array 40 is set on at least one side of the partial optical splitting crystal array 50, and the whole optical splitting crystal array 40 has a plurality of crystals 41 and a retroreflective material 71, the retroreflective material 71 forms a grid, the number of the plurality of crystals 41 is N3×N2, the crystal 41 is set in the retroreflective material 71, that is, the crystal 41 is located in the grid, and the height of the retroreflective material 71 is the same as the height of the crystal 41, so that the top and the bottom of the crystal 41 are cut flush with the top and the bottom of the grid, respectively. Additionally, if the photomultiplier element is a square, N2=N3, that is, the number of the crystals of the whole optical splitting crystal array 40 is N2×N2 or N3×N3.

Therefore, in the present invention, by taking use of the changes of the height of the retroreflective material 70 of the partial optical splitting crystal array 50 and setting the light transmission gap material 52 in the partial optical splitting crystal array 50, the emitted light of the crystal over the non-sensible, discontinuous area 61 is enabled to enter the sensible areas of the two adjacent position sensitive photomultiplier elements 62, so as to solve the problem of discontinuous crystal position response; the residual area is filled with the whole optical splitting crystal array 40 that consists of the crystal arrays with the same or approximately similar sizes, so that the composite crystal array capable of covering the photoelectric matrix 60 shown in FIG. 10 is completed, and the residual area is the area where the position sensitive photomultiplier element 62 does not have a corresponding partial optical splitting crystal array 50.

The composite crystal array can achieve a pixelated gamma camera capable of covering the whole photoelectric matrix, having continuous imaging area, and keeping high resolutions uniform without affecting the resolution under in a cost effective fashion.

The detailed embodiments above are required for the descriptions of features and efficacies of the present invention, and are not intended to limit the scope of the implementation. Any equivalent variations and modification made without departing from the spirit and scope of the technical solutions shall fall within the protection scope of the claims described below.

What is claimed is:

1. A method of making a composite crystal array for a pixelated gamma camera, comprising:
providing dimensional sizes of a first dimension and a second dimension of two adjacent position sensitive photomultiplier elements of a photoelectric matrix, wherein the two adjacent position sensitive photomultiplier elements have a dimensional size Y1 on the first dimension and a dimensional size W2 on the second dimension, a non-sensible, discontinuous area exists between the two position sensitive photomultiplier elements, and the non-sensible, discontinuous area has a dimensional size Y2;
providing a specification for a partial optical splitting crystal array, wherein the partial optical splitting crystal array has a dimensional size W1 on the first dimension, W1 is Y2+(Y1×a ratio)×2, W1 has N1 crystals, and the partial optical splitting crystal array has N2 crystals in the other dimension, so that the total number of the crystals of the partial optical splitting crystal array is N1×N2 and the height of the crystal is L;
providing a retroreflective material of the partial optical splitting crystal array, wherein the height (H) of the retroreflective material is smaller than the height (L) of the crystal and decrements from two outsides (H=L) of the partial optical splitting crystal array towards the center thereof;
providing N1×N2 crystals for a grid structure formed by the retroreflective material of the partial optical splitting crystal array, wherein the N1×N2 crystals are set in the grid made by the retroreflective material, so as to form a partial optical splitting crystal array, a light transmission gap material with is set in each gap, and the height of the light transmission gap material is L−H; and
combining the partial optical splitting crystal array with a whole optical splitting crystal array, wherein the partial optical splitting crystal array is combined with at least one whole optical splitting crystal array to form a whole crystal array.

2. The method of making a composite crystal array for a pixelated gamma camera according to claim 1, wherein the ratio is 3% to 8% and Y2 is 2% to 10% of Y1.

3. The method of making a composite crystal array for a pixelated gamma camera according to claim 1, wherein N1 is an integer and N1 is an even number smaller than 100.

4. The method of making a composite crystal array for a pixelated gamma camera according to claim 1, wherein N2′ is rounded to obtain N2, N2′=W2/(P+S), each crystal has a unilateral size (P) of a crystal particle, P=W1/N1−S, S is a gap of two adjacent crystals in a crystal array, and S is 0.05 mm˜0.3 mm.

5. The method of making a composite crystal array for a pixelated gamma camera according to claim 1, wherein N1 depends on a resolution specification of a camera, a unilateral size P of a crystal particle depends on W1 and N1, and N2 is calculated through P and W2 in combination; an area in which the position sensitive photomultiplier element does not have a corresponding partial optical splitting crystal array is a residual area, which is divided into at least two equal parts by the partial optical splitting crystal array and are filled with the same whole optical splitting crystal array.

6. The method of making a composite crystal array for a pixelated gamma camera according to claim 1, wherein if the size of the crystal array thereof on the second dimension WA2=N2 (P+S), only WA2≦W2 is checked; and if WA2>W2, only a row requires to be reduced, that is, N2′=N2−1.

7. The method of making a composite crystal array for a pixelated gamma camera according to claim 1, wherein the light transmission gap material is transmittable to an incident light with a wavelength of 300 nm˜760 nm and the refractive index thereof is larger than 1.45; the thickness of the material of the retroreflective material is smaller than 100 μm and the surface is able to reflect or absorb an incident light with the wavelength of 300 nm˜760 nm.

8. The method of making a composite crystal array for a pixelated gamma camera according to claim 1, wherein H is obtained from one of a linear-curve equation, a quadratic curve equation, a logarithmic curve equation, and an exponential equation.

9. The method of making a composite crystal array for a pixelated gamma camera according to claim 1, wherein H is H(X)=aX+b; X is the number of a crystal gap, by taking a central gap of the partial optical splitting crystal array 50 as 0, X increments by an integer towards the two sides till X=N1/2, a and b are constants, the range of a is 0.1˜5 and the range of b is 5˜25; or H is H(X)=a×X²+b×X+c, a, b and c are constants, the range of a is 0.2˜1.8, the range of b is −2.8˜5.3 and the range of c is −2˜6.3; H is H(X)=a×exp(b×X), a and b are constants, the range of a is 0.1˜3.1 and the range of b is 0.19˜1.2; or H is H(X)=a×2^{(b×x)}, a and b are constants, the range of a is 0.21˜3.3 and the range of b is 0.1˜2.3; or H is H(X)=a×10^{(b×X)}, a and b are constants, the range of a is 0.13˜3.1 and the range of b is 0.1˜0.9.

10. The method of making a composite crystal array for a pixelated gamma camera according to claim 1, wherein the method of making the whole optical splitting crystal array comprises:
providing a specification for the whole optical splitting crystal array, wherein the whole optical splitting crystal array has a dimensional size (W3) on the first dimension, W3=(Y1−W1)/2, and the dimensional size of the whole optical splitting crystal array on the second dimension is the same with that of the partial optical splitting crystal array, W3 has N3 crystals, so that the total number of the crystals of the whole optical splitting crystal array is N2×N3;
providing a retroreflective material of the whole optical splitting crystal array, wherein the height of the retroreflective material is equal to the height of the crystal; and
providing N2×N3 crystals for a grid structure formed by the retroreflective material of the whole optical splitting crystal array, wherein the N2×N3 crystals are set in the grid made by the retroreflective material, so as to form a whole optical splitting crystal array.

11. The method of making a composite crystal array for a pixelated gamma camera according to claim 10, wherein N3′=W3/(P+S) and N3′ is rounded to obtain N3, each crystal has a size (P), P=W1/N1−S, S is a gap of the two adjacent crystals in the crystal array, and S is 0.05 mm˜0.2 mm.

12. The method of making a composite crystal array for a pixelated gamma camera according to claim 11, wherein the total size of the whole optical splitting crystal array on the first dimension is WA3, WA3=N3 (P+S), WA3/W3=r, r is a ratio; if r=1 or is a number within 97.5%˜102.5%, P does not need to be changed; if r is larger than 102.5%, a row of crystals is reduced, that is, N3″=N3−1, and the size of the crystal 41 is recalculated to be P′=W3/N3″−S; and if r is smaller than 97.5%, a row is added and the size of the crystal 41 is recalculated, that is, N3″=N3+1, and the size of the crystal 41 is P″=W3/N3″−S.

13. The method of making a composite crystal array for a pixelated gamma camera according to claim 1, wherein a sidewall surface of the crystal in the whole optical splitting crystal array is able to be selectively set with a light transmission material or air, and the light transmission material is a light transmission curable adhesive or air.

14. The method of making a composite crystal array for a pixelated gamma camera according to claim 1, wherein the partial optical splitting crystal array is set with a light transmission material; the light transmission gap material is a light transmission curable adhesive in the partial optical splitting crystal array, and is a light transmission curable adhesive or air in the whole optical splitting crystal array.

15. A composite crystal array for a pixelated gamma camera, comprising:
a partial optical splitting crystal array, comprising:
a retroreflective material, forming a grid and having a height H, wherein the height decrements from two sides of the partial optical splitting crystal array towards a center thereof;
a plurality of crystals, wherein each crystal has a height L, L is larger than or equal to H, the crystals are set in the grid, a gap is formed between the sidewalls of each crystal and its neighbor one, and the height of the gap is L−H; and
a light transmission gap material set in the gap; and
at least one whole optical splitting crystal array set on at least one side of the partial optical splitting crystal array.

16. The composite crystal array for a pixelated gamma camera according to claim 15, wherein the light transmission gap material is transmittable to an incident light with a wavelength of 300 nm˜760 nm and the refractive index thereof is larger than 1.45; the thickness of the retroreflective material is smaller than 100 μm, and the surface is able to reflect or absorb an incident light with a wavelength of 300 nm˜760 nm.

17. The composite crystal array for a pixelated gamma camera according to claim 15, wherein the light transmission gap material is a light transmission curable adhesive in the partial optical splitting crystal array and is a light transmission curable adhesive or air in the whole optical splitting crystal array.

18. The composite crystal array for a pixelated gamma camera according to claim 15, wherein the surface of the crystal is able to be selectively set with a light transmission material, the light transmission material is a light transmission curable adhesive or air, and a light transmission material is set in partial optical splitting crystal array.

19. The composite crystal array for a pixelated gamma camera according to claim 15, wherein the whole optical splitting crystal array comprises:
a retroreflective material forming the grid; and
a plurality of crystals set in the grid and the top and the bottom of each crystal are cut flush with the top and bottom of the grid, respectively.
